(19) United States
(12) Patent Application Publication
(10) Pub. No.: US 2004/0014934 A1
(43) Pub. Date: Jan. 22, 2004

(54) Method for the production of polyestercarbonates

(75) Inventors: Herman Otto Krabbenhoft, Scotia, NY (US); Mohan Mark Amaratunga, Clifton Park, NY (US); David Paul Mobley, Niskayuna, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company

(21) Appl. No.: 10/199,643

(22) Filed: Jul. 19, 2002

(51) Int. Cl. C08G 64/00

(52) U.S. Cl. 528/370; 528/372

(57) ABSTRACT

A method for the production of a polyestercarbonate comprises (i) providing at least one dihydroxyaromatic compound (ii) providing a carbonate precursor and (iii) providing at least one solid, biosynthetically derived, aliphatic alpha-omega dicarboxylic acid having about 10 to about 22 carbon atoms and having a nitrogen content of not more than about 55 ppm, and reacting interfacially in the presence of a base said dihydroxyaromatic compound, said carbonate precursor and said dicarboxylic acid.

This invention was made with government support under contract No. 70NANB8H4033 awarded by NIST/ATP. The government may have certain rights to the invention.

### BACKGROUND OF INVENTION

The invention relates generally to a process for the production of polyestercarbonates. Polycarbonates are known to be tough, clear, impact resistant thermoplastic resins. However, polycarbonates possess a relatively high melt viscosity. In order to prepare molded articles, relatively high extrusion and molding temperatures are required. Various efforts throughout the years to reduce the melt viscosity while also maintaining the physical properties of polycarbonates have been attempted. These methods include the use of plasticizers, aliphatic chain stoppers and also a reduction of molecular weight. However, the use of plasticizers leads to undesirable characteristics like embrittlement. Polyestercarbonates made by incorporating ester moieties into polycarbonates often have favorable melt viscosity. In particular, polyestercarbonates derived from bisphenol A (sometimes abbreviated hereinafter as BPA), long chain aliphatic dicarboxylic acids and a carbonate generating species have outstanding performance including high impact resistance and the advantage of relatively low melt viscosity. Although a standard interfacial process utilizing the dicarboxylic acid chloride derivative of saturated aliphatic alpha-omega dicarboxylic acids can be employed to prepare the polyestercarbonate, the availability of the dicarboxylic acid chloride starting material is a problem. Aliphatic dicarboxylic acid chlorides are commercially available only in limited quantities and at a high cost. Attention has thus been focused on inexpensive aliphatic dicarboxylic acids which are prepared by a biosynthetic route. However, because of the low solubility of these dicarboxylic acids in brine, some of these acids are left unincorporated at the conclusion of the interfacial polymerization reaction for the preparation of the polyestercarbonates. The unincorporated dicarboxylic acid, typically visible as particles at the resin solution-brine interface, seriously interferes with the electrochemical recycling of the brine solution. Also, unincorporated diacid is an inefficient use of the diacid starting material. Another problem with the use of a biosynthetically prepared dicarboxylic acid is the formation of an emulsion or rag layer which impedes the separation of the resin and brine solutions after the polymerization reaction is complete. The emulsion results in the organic components comprising polyestercarbonates being carried into the brine solution and in hampering the recycling operations. It would therefore be desirable to minimize the amount of unincorporated dicarboxylic acids in the reaction mixture, as well as prevent the formation of the rag or emulsion layer.

### SUMMARY OF INVENTION

Briefly, in accordance with one embodiment of the present invention, a method is provided for the production of a polyestercarbonate which comprises (i) providing at least one dihydroxyaromatic compound (ii) providing a carbonate precursor, (iii) providing at least one solid, biosynthetically derived, aliphatic alpha-omega dicarboxylic acid having about 10 to about 22 carbon atoms and having a nitrogen content of not more than about 55 ppm, and reacting interfacially in the presence of a base said dihydroxyaromatic compound, said carbonate precursor and said aliphatic dicarboxylic acid.

The embodiments of the present invention have many advantages, including a greater level of incorporation of dicarboxylic acid into the polyestercarbonate product and reduced rag layer formation in the interfacial production of polyestercarbonates. Various other features, aspects, and advantages of the present invention will become more apparent with reference to the following description and appended claims.

### DETAILED DESCRIPTION

Suitable dihydroxyaromatic compounds include those represented by the formula (I):

HO—D—OH (I)

wherein D is a divalent aromatic radical. In some embodiments, D has the structure of formula (II):

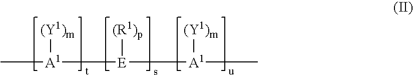

wherein A¹ represents an aromatic group such as phenylene, biphenylene, naphthylene, etc. E may be an alkylene or alkylidene group such as methylene, ethylene, ethylidene, propylene, propylidene, isopropylidene, butylene, butylidene, isobutylidene, amylene, amylidene, isoamylidene, etc. Where E is an alkylene or alkylidene group, it may also consist of two or more alkylene or alkylidene groups connected by a moiety different from alkylene or alkylidene, such as an aromatic linkage; a tertiary amino linkage; an ether linkage; a carbonyl linkage; a silicon-containing linkage; or a sulfur-containing linkage such as sulfide, sulfoxide, sulfone, etc.; or a phosphorus-containing linkage such as phosphinyl, phosphonyl, etc. In addition, E may be a cycloaliphatic group e.g., cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, etc.; a sulfur-containing linkage, such as sulfide, sulfoxide or sulfone; a phosphorus-containing linkage, such as phosphinyl, phosphonyl; an ether linkage; a carbonyl group; a tertiary nitrogen group; or a silicon-containing linkage such as silane or siloxy. R¹ represents hydrogen or a monovalent hydrocarbon group such as alkyl, aryl, aralkyl, alkaryl, or cycloalkyl. Y¹ may be an inorganic atom such as halogen (fluorine, bromine, chlorine, iodine); an inorganic group such as nitro; an organic group such as alkenyl, allyl, or R¹ above, or an oxy group such as OR wherein R is an alkyl group; it being only necessary that Y¹ be inert to and unaffected by the reactants and reaction conditions used to prepare the polymer. The letter “m” represents any integer from and including zero through the number of positions on Al available for substitution; “p” represents an integer from and including zero through the number of positions on E available for substitution; “t” represents an integer equal to at least one; “s” is either zero or one; and “u” represents any integer including zero.

In the dihydroxyaromatic compound in which D is represented by formula (II) above, when more than one Y substituent is present, they may be the same or different. The same holds true for the R¹ substituent. Where “s” is zero in formula (II) and “u” is not zero, the aromatic rings are directly joined with no intervening alkylidene or other bridge. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with y¹ and hydroxyl groups. In some particular embodiments the parameters “t”, “s”, and “u” are each one; both A¹ radicals are unsubstituted phenylene radicals; and E is an alkylidene group such as isopropylidene. In some particular embodiments both A¹ radicals are p-phenylene, although both may be o- or m-phenylene or one o- or m-phenylene and the other p-phenylene.

In some embodiments, dihydroxyaromatic compounds are of the formulae:

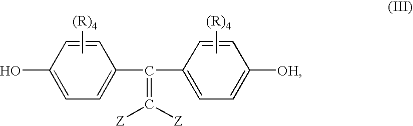

where independently each R is hydrogen, chlorine, bromine or a C₁₋₃₀ monovalent hydrocarbon or hydrocarbonoxy group, each Z is hydrogen, chlorine or bromine, subject to the provision that at least one Z is chlorine or bromine, and

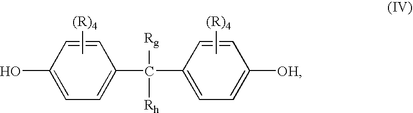

where independently each R is as defined herein-before, and independently R_{g} and Rₕ are hydrogen or a C₁₋₃₀ hydrocarbon group.

In embodiments of the present invention dihydroxyaromatic compounds that may be used include those described in U.S. Pat. Nos. 2,991,273, 2,999,835, 3,028,365, 3,148172, 3,271,367, and 3,271,368. In addition, some illustrative, non-limiting examples of dihydroxyaromatic compounds of formula (I) include the dihydroxyaromatic compounds disclosed by name or formula (generic or specific) in U.S. Pat. No. 4,217,438. Some particular examples of dihydroxyaromatic compounds include 4,4′-(3,3,5-trimethylcyclohexylidene)diphenol; 4,4′-bis(3,5-dimethyl)diphenol, 1,1 -bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1 -bis(4-hydroxy-2-chlorophenyl)ethane; 2,2-bis(4-hydroxyphenyl)propane (commonly known as bisphenol A); 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; 2,6-dihydroxy naphthalene; hydroquinone; resorcinol; C₁₃ alkyl-substituted resorcinols.

Examples of other suitable dihydroxyaromatic compounds include 2,2-bis-(4-hydroxyphenyl)-butane; 2,2-bis-(4-hydroxyphenyl)-2-methylbutane; 1,1 -bis-(4-hydroxyphenyl)-cyclohexane; bis-(4-hydroxyphenyl); bis-(4-hydroxyphenyl)-sulphide; 2-(3-methyl-4-hydroxyphenyl-2-(4-hydroxyphenyl)-propane; 2-(3,5-dimethyl-4-hydroxyphenyl)-2-(4-hydroxyphenyl)-propane; 2-(3-methyl-4-hydroxyphenyl)-2-(3,5-dimethyl-4-hydroxyphenyl)-propane; bis-(3,5-dimethylphenyl-4-hydroxyphenyl)methane; 1,1-bis-(3,5-dimethylphenyl-4-hydroxyphenyl)ethane; 2,2-bis-(3,5-dimethylphenyl-4-hydroxyphenyl)propane; 2,4-bis-(3,5-dimethylphenyl-4-hydroxyphenyl)-2-methyl-butane; 3,3-bis-(3,5-dimethylphenyl-4-hydroxyphenyl)pentane; 1,1-bis-(3,5-dimethylphenyl-4-hydroxyphenyl)cyclopentane; 1,1-bis-(3,5-dimethylphenyl-4-hydroxyphenyl)cyclohexane; bis-(3,5-dimethylphenyl-4-hydroxyphenyl)-sulphide.

Suitable dihydroxyaromatic compounds also include those containing indane structural units such as represented by the formula (V), which compound is 3-(4-hydroxyphenyl)-1,1,3-trimethylindan-5ol, and by the formula (VI), which compound is 1-(4-hydroxyphenyl)-1,3,3-trimethylindan-5-ol:

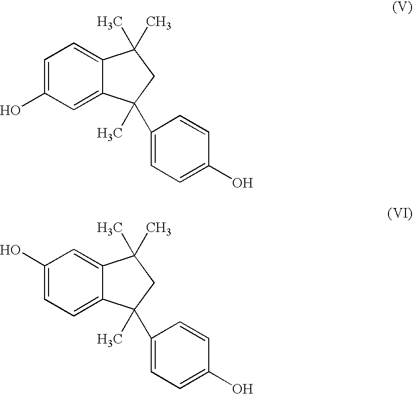

Also included among suitable dihydroxyaromatic compounds are the 2,2,2′,2′-tetrahydro-1,1′-spirobi [1H-indene] diols having formula (VII):

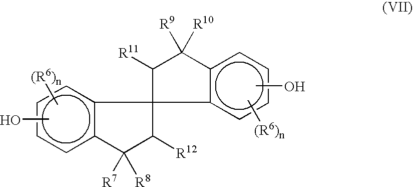

wherein each R⁶ is independently selected from monovalent hydrocarbon radicals and halogen radicals; each R⁷, R⁸, R⁹, and R¹⁰ is independently C₁₋₆ alkyl; each R¹ and R12 is independently H or C₁₋₆ alkyl; and each n is independently selected from positive integers having a value of from 0 to 3 inclusive. In a particular embodiment the 2,2,2′,2′-tetrahydro-1,1′-spirobi[1H-indene] diol is 2,2,2′,2′-tetrahydro-3,3,3′,3′-tetramethyl-1,1′-spirobi[1H-indene]-6,6′-diol (sometimes known as “SBI”).

The term “alkyl” as used in the various embodiments of the present invention is intended to designate both normal alkyl, branched alkyl, aralkyl, cycloalkyl, and bicycloalkyl radicals. In various embodiments normal and branched alkyl radicals are those containing from 1 to about 30 carbon atoms, and include as illustrative non-limiting examples methyl, ethyl, n-propyl, isopropyl, n-butyl, sec-butyl, tertiary-butyl, pentyl, neopentyl, hexyl, heptyl, octyl, nonyl, decyl, undecyl and dodecyl. In various embodiments cycloalkyl radicals are those containing from 3 to about 12 ring carbon atoms. Some illustrative non-limiting examples of these cycloalkyl radicals include cyclobutyl, cyclopentyl, cyclohexyl, methylcyclohexyl, and cycloheptyl. In various embodiments aralkyl radicals are those containing from 7 to about 14 carbon atoms; these include, but are not limited to, benzyl, phenylbutyl, phenylpropyl, and phenylethyl. In various embodiments aryl radicals used in the various embodiments of the present invention are those containing from 6 to 18 ring carbon atoms. Some illustrative non-limiting examples of these aryl radicals include phenyl, biphenyl, and naphthyl.

The carbonate precursor used in the present invention may be one of the standard carbonate precursors used in interfacial reactions, such as phosgene. When using an interfacial process, it is often desired to use a standard catalyst system well known in the preparation of polyestercarbonates. A typical catalyst is a tertiary amine, as for example aliphatic amines and heterocyclic amines. In certain embodiments, the amine is a trialkylamine containing no branching on the carbon atoms in the 1- and 2- positions. In many embodiments, triethylamine is used as the catalyst. The amine catalyst may be used within a range of about 0.75 mole % to about 5 mole % based on the weight of the dihydroxyaromatic compound used. In one embodiment, about 2 mole % to about 5 mole % of the amine is used. In a second embodiment, about 3 mole % to about 6 mole % of the amine catalyst is used. In alternate embodiments, a phase transfer catalyst may be used. These catalysts may include for example ammonium salts and phosphonium salts as well as hexaalkylguanidinium halides and crown ethers. In a particular embodiment a catalyst of this type is benzyltrimethylammonium chloride.

A chain-terminating agent is usually added to control the molecular weight of the polymer product being formed. Examples include, but need not be limited to, phenol, p-t-butyl-phenol and p-cumyl-phenol. Phenol is often used in many embodiments of the present invention. In one embodiment of the present invention the chain stoppers are usually present in the range from about 2 mole percent to about 10 mole percent based on the weight of the dihydroxyaromatic compound. In a second embodiment they are present in the range from about 3 mole percent to about 7 mole percent based on the weight of the dihydroxyaromatic compound. In many embodiments, the chain stopper is present in the range from about 3 mole percent to about 5 mole percent based on the weight of the dihydroxyaromatic compound.

The ester units in the polyestercarbonate are derived from at least one aliphatic alpha-omega dicarboxylic acid or a functional equivalent thereof, such as a corresponding ester or acid halide, for example a diacid chloride. In particular embodiments the ester units are derived from at least one aliphatic alpha-omega dicarboxylic acid which is derived from a biosynthetic process. In the present context a biosynthetic process is one which comprises transformation of one organic compound into another organic compound using a living organism or an enzyme derived from a living organism. In one embodiment, the dicarboxylic acid moiety contains from about 10 to about 22 carbon atoms, in another embodiment from about 10 to about 20 carbon atoms, in another embodiment from about 10 to about 18 carbon atoms, in another embodiment from about 10 to about 16 carbon atoms, and in still another embodiment from about 12 to about 14 carbon atoms. In a particular embodiment the dicarboxylic acid moiety contains 18 carbon atoms. The dicarboxylic acid moiety may be normal, branched or cyclic, and may contain unsaturation. Examples of suitable dicarboxylic acids include sebacic acid, dodecanedioic acid, C₁₄, C₁₆, C₁₈, C₂₀ and C₂₂ dicarboxylic acids, and mixtures thereof. Examples of suitable unsaturated dicarboxylic acids that can be used include mono-unsaturated dicarboxylic acids such as cis-octadec-9-enedioic acid, trans-octadec-9-enedioic acid, cis-hexadec-9-enedioic acid, trans-hexadec-9-enedioic acid, cis-tetradec-7-enedioic acid, trans-tetradec-7-enedioic acid, trans-tetradec-5-enedioic acid, cis-tetradec-5-enedioic acid, cis-hexadec-7-enedioic acid, trans-hexadec-7-enedioic acid, and cis-eicos-10-enedioic acid. In some embodiments, cis-octadec-9-enedioic acids are used and in some other embodiments trans-octadec-9-enedioic acids are used. The cis isomer is used in many of the embodiments. Mixtures of different types of dicarboxylic acids may also be employed. In a particular embodiment mixtures of saturated and unsaturated dicarboxylic acids may be employed.

It should be understood that mixtures of geometric isomers of mono-unsaturated aliphatic dicarboxylic acids may also be used to prepare the polyestercarbonates of the present invention. For example, cis and trans isomers of the same dicarboxylic acid or of different dicarboxylic acids may be employed. Moreover, mixtures of mono-unsaturated or saturated aliphatic dicarboxylic acids of the same or different carbon number could be employed, for example mixtures of those containing between 10 to 22 carbon atoms. Such mixtures often result when dicarboxylic acids are obtained by way of biosynthetic processes as further described hereinbelow. In a particular embodiment there may be employed a mixture of at least one saturated dicarboxylic acid with at least one mono-unsaturated dicarboxylic acid. In another particular embodiment cis-octadec-9-enedioic acid is used in combination with octadecanedioic acid.

In one embodiment, the amount of any unsaturated dicarboxylic acid used is no more than about 20% by weight of the total mixture of dicarboxylic acids to ensure desired glass transition properties for the resulting polyestercarbonates. In a second embodiment, any unsaturated dicarboxylic acid is used in no greater than about 10% by weight of the total mixture of dicarboxylic acids while in third embodiment any unsaturated dicarboxylic acid used is no more than about 5% by weight of the total mixture of dicarboxylic acids. In many embodiments, the amount of any unsaturated dicarboxylic acid used is no greater than about 2% by weight of the total mixture of dicarboxylic acids. In another particular embodiment only a saturated dicarboxylic acid or mixture of saturated dicarboxylic acids is used in polyestercarbonate synthesis.

The total level of dicarboxylic acid present will depend on various factors such as the type of dihydroxyaromatic compound employed, the specific dicarboxylic acid or mixture of dicarboxylic acids used, the desired molecular weight and glass transition temperature of the resulting polyestercarbonate. In some embodiments, the acid or mixture of acids is present at a level from about 4 mole % to about 15 mole % based on the total moles of the polyestercarbonate polymer. In a second embodiment, the level is from about 6 mole % to about 12 mole % while in a third embodiment, the level may be from about 10 mole % to about 12 mole % based on the total moles of the polyestercarbonate polymer. In a particular embodiment the level of acid or mixture of acids may be from about 10 mole % to about 12 mole % based on the total moles of the polyestercarbonate polymer. In another particular embodiment the level of acid or mixture of acids varies from about 12 mole % to about 15 mole % based on the total moles of the polyestercarbonate polymer. In another particular embodiment the level of acid or mixture of acids varies from about 4 mole % to about 8 mole % based on the total moles of the polyestercarbonate polymer.

Dicarboxylic acids used in the present invention may be made by conventional organic synthesis techniques, adapting the methods used to prepare monocarboxylic acids. These methods are well known in the art. Dicarboxylic acids used in the present invention may also be made by biosynthetic techniques. It is well known that fatty monocarboxylic acids upon which fats (triglycerides) are based, are all straight-chain compounds, ranging from about 8 to about 18 carbon atoms. In general, only acids with an even number of carbon atoms are present in substantial amounts. Fat molecules are built up, two carbons at a time, from acetate units, according to a set of steps that are similar to the malonic ester synthesis typically undertaken by an organic chemist. Those individuals who are familiar with biosynthesis and have ordinary skill in the art of organic synthesis will be able to prepare the desired dicarboxylic acid from fatty mono-carboxylic acid without undue experimentation. The biotransformation may occur in the presence of various strains of yeasts including strains of Candida tropicalis as disclosed, for example, in U.S. Pat. 5,620,878 and 5,962,285.

Dicarboxylic acids synthesized by biotransformation may have organic nitrogen-containing impurities derived, for example, from proteins and other biological sources. Analytical methods for monitoring the concentration of nitrogen in the dicarboxylic acid are well known to those skilled in the art and may be applied as appropriate depending upon the degree of accuracy desired. The present inventors have used dicarboxylic acids with reduced nitrogen levels to reduce the emulsion effect or rag layer effect in the interfacial process of polyestercarbonate manufacture. In various embodiments said rag layer is essentially eliminated meaning that little or no intermediate layer is observed between an aqueous phase and an organic phase following completion of polyestercarbonate synthesis by an interfacial method. The level of nitrogen in the dicarboxylic acid is in one embodiment in a range of from about 0 to about 500 ppm, in another embodiment in a range of from about 5 to about 400 ppm, in another embodiment in a range of from about 5 to about 200 ppm, in another embodiment in a range of from about 5 to about 100 ppm, in another embodiment in a range of from about 5 to about 80 ppm and in still another embodiment in a range of from about 5 to about 55 ppm. In one particular embodiment the level of nitrogen in the dicarboxylic acid is in a range of from about 0 to about 80 ppm, and in another particular embodiment in a range of from about 0 to about 60 ppm. In another particular embodiment, the level of nitrogen in the dicarboxylic acid is not more than about 100 ppm. In still another particular embodiment, the level of nitrogen in the dicarboxylic acid is not more than about 55 ppm.

In various embodiments the present invention comprises a process for the manufacture of polyestercarbonates by an interfacial process, which uses the reaction of a dihydroxyaromatic compound and a carbonate precursor with a dicarboxylic acid moiety, wherein the dicarboxylic acid moiety is provided as a solid. The present inventors have overcome problems caused by unincorporated dicarboxylic acid solid particles by a particle size reduction, which facilitates dissolution of the said dicarboxylic acid. The particle size reduction may be carried out by any convenient method. In one embodiment particle size reduction may be carried out by grinding the dicarboxylic acid in a pestle and mortar, or in a mechanical mixer or mechanical grinder. The dicarboxylic acids may be sieved with a mesh of about 100 mesh size in one embodiment and in a second embodiment with a sieve of about 200 mesh size. In a third embodiment, a sieve of about 500 mesh size may be employed. The fraction collecting below the sieve is typically used in the preparation of the polyestercarbonate. The reduction in particle size leads to an elimination of the layer of particles at the resin solution-brine interface and allows an efficient recycling of brine by the well-known electrolysis method. The particle size of the solid dicarboxylic acid used is typically from about 10 microns to about 500 microns in one embodiment of the present invention while it is from about 50 microns to about 200 microns in a second embodiment of the invention. In a third embodiment of the invention, the particle size of the dicarboxylic acid used is from about 70 microns to about 150 microns. In many embodiments, the mean particle size of the dicarboxylic acid used is from about 10 microns to about 110 microns. In a particular embodiment the mean particle size of the dicarboxylic acid is not more than about 105 microns.

Analytical methods for monitoring the concentration of unincorporated dicarboxylic acid in the reaction mixture are well known to those skilled in the art and may be applied as appropriate depending upon the degree of accuracy desired. Incorporation of substantially all the dicarboxylic acid into the polyestercarbonate in the present context means that in one embodiment, greater than about 95 mole % of the dicarboxylic acid added has been incorporated, in another embodiment, greater than about 98 mole % of the dicarboxylic acid added has been incorporated and in another embodiment, greater than about 99 mole % of the dicarboxylic acid added has been incorporated. In a particular embodiment, incorporation of essentially all the dicarboxylic acid means that none can be detected using the chosen analytical method. In another particular embodiment incorporation of essentially all the dicarboxylic acid means that none can be visually detected at the interface of aqueous phase and organic phase of the reaction mixture, and that none can be isolated by filtration or other solid separation method applied to the reaction mixture.

In some embodiments for the preparation of the polyestercarbonates by the interfacial process, the pH of the reaction system is adjusted in steps. Generally, a pH range of about 8 to about 9 is maintained during the first 50-95% of the phosgenation reaction. In a particular embodiment the pH is maintained at about 8 during the first about 50-95% of the phosgenation reaction (sometimes referred to as the initial part of the phosgenation reaction). In another particular embodiment the pH is maintained in a range of about 7.5 and about 8.5 during the first about 50-95% of the phosgenation reaction. In another particular embodiment the pH is maintained in a range of about 7.8 and about 8.5 during the first about 50-95% of the phosgenation reaction. In another particular embodiment the pH is maintained in a range of about 7.9 and about 8.4 during the first about 50-95% of the phosgenation reaction. After that period, the pH of the reaction mixture is raised to a level in a range of about 10 to about 12. In some embodiments, the pH is raised to a level in a range of about 10.5 to about 13 while the remainder of the phosgenation is carried out. An excess of phosgene is usually employed to ensure as complete a reaction as possible. Sometimes, a pre-equilibrium of the reactants (other than phosgene) is carried out at the initial reaction pH, for a period of time that is for example from about 3 to about 10 minutes. In some embodiments, the pre-equilibrium time is from about 5 minutes to about 15 minutes and in another embodiment, the pre-equilibrium time is from about 20 minutes to about 30 minutes. The pre-equilibrium time, if any, will typically depend upon a number of factors including, but not limited to, size of reaction vessel, volume of solvents, concentration of reactants, temperature, stirring configuration, and stirring rate. The polyestercarbonate polymer has a weight average molecular weight in one embodiment in the range of about 40,000 to about 170,000, in another embodiment in the range of about 45,000 to about 95,000, in another embodiment in the range of about 50,000 to about 85,000, in another embodiment in the range of about 50,000 to about 70,000, and in another embodiment in the range of about 50,000 to about 60,000 relative to polystyrene standards. The polyestercarbonate has a glass transition temperature in one embodiment in the range of about 85° C. to about 175° C.; in another embodiment in the range of about 120° C. to about 160° C.; in another embodiment in the range of about 120° C. to about 155° C.; and in still another embodiment in the range of about 120° C. to about 140° C.

Other details regarding the preparation of polyestercarbonates can be found in various sources, such as the following patents: U.S. Pat. Nos. 5,274,068, 5,025,081, 4,983,706 and 4,286,083, and 5,959,064. The aliphatic dicarboxylic acid can be charged to the reactor as a solid or can be added in the form of a solid salt with the particular dihydroxyaromatic compound being employed as for example bisphenol A. Moreover, if a chain stopper is employed, it can be added to the reaction vessel initially, or can be added at a later stage. The reactor can be charged initially with an organic solvent as for example methylene chloride. The carbonate precursor, such as phosgene, is typically added after the other components are present in the reaction vessel. The pH controlling component, as for example aqueous sodium hydroxide is typically added during the reaction, for example during phosgenation. Other useful details can be found in the examples that follow.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner

BPA (bisphenol-A), manufactured by Shell Corporation was used as received. The PCP (4-cumylphenol) and TEA (triethylamine) were obtained from Aldrich Chemical Co and used as received. The DDDA (dodecanedioic acid), manufactured by DuPont was used as received. Peptone was obtained from Difco. The biosynthetic diacids were made by Cognis and used as received (except in those instances where the material was ground to smaller particle sizes). The 33% caustic solution utilized in the polymerization reactions was prepared by appropriate dilution of commercially available 50% sodium hydroxide solution, obtained from J.T. Baker. The biosynthetic diacids were ground mechanically with a Brinkman ZM-1 High Speed Centrifugal Grinding Mill. The ground material was then sieved with U.S.A. Standard Testing Sieves, such as a 140 mesh (106 microns) sieve. General Procedure for Synthesis of polyestercarbonates

A 500 milliliter (mL) 5-necked, round-bottomed, glass Morton polymerization flask was equipped with a mechanical stirrer shaft and a pH electrode and fitted with a caustic addition tube and a phosgene gas delivery tube, and a water-cooled Liebig condenser whose efflux end was connected to a series of 3 scrubbers of potassium hydroxide dissolved in aqueous methanol. To the flask were added 38.6688 grams (g) (0.169385 mole) of BPA, 3.3858 g (0.010768 mole) of 1,18-octadecanedioic acid, 0.9605 g (0.004523 mole) of PCP, 133 mL of methylene chloride, 71 mL of water, and 390 microliters of TEA. Other dicarboxylic acids were used in place of 1,18-octadecanedioic acid as shown in the data tables. The mixture was stirred at about 250 rpm. The pH electrode was connected to a Cole-Parmer model 5656-00 pH/ORP controller, interfaced with a Masterflex model 7014-52 pump for delivering the aqueous 33% caustic solution. The pH controller was initially set at 8.0. Before the addition of any caustic solution, the pH of the reaction mixture was 7.3. The caustic pump was turned on. The phosgene delivery system, previously programmed to deliver 1.22 equivalents of phosgene at the rate of 0.600 g/minute, was then turned on. In this run, the total amount of phosgene to be delivered was 22.0091 g (0.2225 mole). The corresponding amount of 33% caustic solution to be delivered was 63.66 g (0.5252 mole of sodium hydroxide). During the reaction, the pH, mass of caustic solution, reaction color (white or gray), and the phosgene flow rate were recorded after the addition of each gram of phosgene. After the addition of 50% of the total phosgene, the pH was controller adjusted to a pH of 10.5 at the rate of 0.3 pH units every 30 seconds. After the specified amount of phosgene was delivered, the phosgene flow was stopped and nitrogen was bubbled into the reaction vessel. After 5 minutes of purging with nitrogen, the reaction mixture was worked up as follows. The reaction mixture was transferred to a 1 pint glass bottle. The polymerization flask was rinsed with 100 mL of methylene chloride and 25 mL of water, the rinses being added to the reaction mixture. The diluted reaction mixture was placed on a shaker for 5 minutes. The mixture was then divided into two 8 ounce plastic bottles that were then centrifuged for 5 minutes. The separated phases were carefully transferred to a 500 mL separatory funnel. The plastic bottles were rinsed with a total of 10 mL of methylene chloride, the rinses being added to the separatory funnel. The lower resin solution was drained into a 1 pint bottle containing 100 mL of IN hydrochloric acid solution, which was then placed on a shaker for 5 minutes. The upper brine solution was drained into an 8 ounce glass bottle and saved for subsequent analysis. The mixture of resin solution and hydrochloric acid solution was then transferred to two 8 ounce plastic bottles that were then centrifuged. This process was repeated so as to give a total of 2 hydrochloric acid washes and 4 water washes, all of the acid or water washes being discarded. The final resin solution was then transferred to a 250 mL separatory funnel and treated as follows. In a 5 liter (L) stainless steel Waring blender (rendered hot with a heat gun) was placed 3600 mL of boiling hot water. With high speed stirring of the hot water, the resin solution was discharged via a steady stream into the hot water. The precipitated resin was isolated by vacuum filtration and then dried in a vacuum oven (about 85° C., 25 inches Hg vacuum) with a nitrogen sweep. The dried resin was then analyzed and characterized.

Glass transition measurements were conducted using a Differential scanning calorimeter (Perkin Elmer DSC-7) interfaced with a Perkin Elmer TAC 7/DX thermal analysis controller. Gel permeation chromatography data was obtained using a HP 1090 instrument equipped with 2 styrogel HR 5 E columns in series with a 260 nanometer (nm) UV detector. Polystyrene samples were used as standard for the calibration. The quantity of unincorporated dicarboxylic acid particles was estimated by letting a sample of a batch of polyestercarbonate reaction mixture comprising organic solvent and water stand overnight in a measuring cylinder and then measuring the length of the layer of particles. The same procedure was adopted for the estimation of rag layer wherein the layer was allowed to stand overnight. The length of the layer was then estimated using a millimeter scale. Total nitrogen measurements on dicarboxylic acid samples were done on an Antek 9000 Nitrogen Analyzer. Light emitted from the decaying metastable species was detected by chemiluminescent emission. Only chemically bound nitrogen was detected. The limit of detection for the method was 5 ppm and the limit of quantification was 13 ppm. The analyte concentration was calculated by comparison with a series of known standards. The calibration was prepared as total nitrogen, which was converted to ppm, based on the weight of sample analyzed. To calibrate, a certified standard was dissolved in water and introduced into the instrument using tin sample cups.

Table 1 gives data on rag layer formation as a function of nitrogen content in the dicarboxylic acid used. The abbreviation “DCA” stands for dicarboxylic acid. Samples of saturated dicarboxylic acids were derived from a biosynthetic process unless noted and were obtained from Cognis. Unsaturated C-18 dicarboxylic acids used in the experiments were also obtained from Cognis and comprised cis-octadec-9-enedioic acid. Also, synthetic dicarboxylic acids, not prepared by a biosynthetic method and either obtained from a commercial source or synthesized in-house as noted, were used for other rag layer experiments.

TABLE 1

| | | | Nitrogen |
|---|---|---|---|
| | | Content | Rag Layer |
| Example | DCA | (ppm) | formation |
| 1 | DDDA (obtained from | 23 | No |
| | commercial source) | | |
| 2 | Saturated C-18 | 900 | Substantial |
| 3 | Saturated C-18 | 200 | No, but substantial |
| | | | amount of solid |
| 4 | Saturated C-18 | 88 | Substantial |
| 5 | Saturated C-18 | 52 | No |
| 6 | Saturated C-18 | 49 | No |
| 7 | Saturated C-18 | 41 | No |
| 8 | Saturated C-18 (obtained | 14 | No |
| | from commercial source) | | |
| 9 | Saturated C-18 | 6 | No, but slight |
| | (synthesized in-house) | | amount of solid |
| 10 | Unsaturated C-18 | 190 | Substantial |
| 11 | Unsaturated C-18 | 150 | Substantial |
| 12 | Unsaturated C-18 | 89 | Substantial |
| 13 | Unsaturated C-18 | 48 | Slight |

In some cases some solid was observed at the interface between aqueous and organic layers as noted in the column for “Rag Layer Formation”.

Table 2 shows the effect on rag layer formation of various levels of peptone spiked into polyestercarbonate reaction mixtures made using DDDA having 23 ppm Nitrogen.

TABLE 2

| Example | ppm Nitrogen Added | Rag Layer Formation? |
|---|---|---|
| 14 | 0 | no |
| 15 | 50 | no |
| 16 | 100 | some |
| 17 | 250 | substantial |
| 18 | 500 | substantial |

Table 3 gives the effect of particle size on unincorporated dicarboxylic acids used in the interfacial polymerization process for the manufacture of polyestercarbonates. A saturated C-18 biosynthetic dicarboxylic acid (obtained from Cognis) was used for studies of incorporation. Pestle and mortar grinding as well as mechanical griding was used to reduce particle size and check the effect of reduced particle size incorporation.

TABLE 3

| Example | Particle Size Description | Solid Particles at Interface? |
|---|---|---|
| 19 | mortar and pestle ground | significant amount of solid |
| 20 (note 1) | mortar and pestle ground | significant amount of solid |
| 21 | mortar and pestle ground | some solid; less than with |
| | | examples 19 and 20 |
| 22 | mechanically ground; not | some solid; less than with runs |
| | sieved | 19 and 20 |
| 23 | mechanically ground and | no visible solid |
| | sieved: −140/+325 | |
| 24 | mechanically ground and | substantial amount of solid |
| | sieved: +70 | |
| 25 | mechanically ground and | very small amount of fine solid |
| | sieved: −70/+140 | |
| 26 | mechanically ground and | no visible solid |
| | sieved: −140/+200 | |
| 27 (note 2) | mechanically ground and | substantial amount of solid |
| | sieved: −140/+200 | |
| 28 | mechanically ground and | trace amount of very fine solid |
| | sieved: −100/+140 | |

Note 1.
The phosgenation was carried out in two stages: half the normal phosgene flow rate for twice the time for the pH 8 reaction phase, followed by the usual phosgene flow rate for the pH ramp and pH 10 phase.
Note 2.
The phosgenation was carried out at pH 9 before the pH ramp to 10.5.

Table 4 gives the glass transition temperature and molecular weight data of polyestercarbonates made by the interfacial process. Samples of biosynthetic saturated dicarboxylic acids obtained from Cognis chemicals were used for polyestercarbonate syntheses. Also, synthetic dicarboxylic acids, not prepared by a biosynthetic method and either obtained from a commercial source or synthesized in-house as noted, were used for other polyestercarbonate syntheses.

TABLE 4

| | | Nitrogen | | Tg | | Mw | | | |
|---|---|---|---|---|---|---|---|---|---|
| | | Content | # | (° C.) | | (Daltons) | | Mw/Mn | |
| Example | DCA | (ppm) | runs | range | median | range | median | range | median |
| 29 | DDDA | — | 6 | 129.3 | 129.3 | 59,300- | 63,000 | 2.22- | 2.28 |
| | (chemically | | | | | 64,000 | | 3.14 | |
| | synthesized) | | | | | | | | |
| 30 | DDDA | — | 7 | 128.9- | 129.5 | 51,400- | 63,300 | 2.00- | 2.15 |
| | (chemically | | | 130.8 | | 74,600 | | 2.56 | |
| | synthesized) | | | | | | | | |
| 31 | C18 (obtained | 14 | 2 | 125.4- | 127.0 | 65,500- | 70,500 | 1.97- | 2.11 |
| | from commercial | | | 128.5 | | 75,600 | | 2.19 | |
| | source) | | | | | | | | |
| 32 | C18 (synthesized | 6 | 3 | 127.8- | 129.6 | 57,600- | 66,200 | 2.16- | 2.18 |
| | in-house) | | | 129.9 | | 68,700 | | 2.26 | |
| 33 | C18 | 41 | 5 | 129.3- | 130.0 | 75,600- | 79,800 | 2.18- | 2.25 |
| | | | | 131.3 | | 94,700 | | 2.26 | |
| 34 | C18 | 49 | 1 | 130.3 | 130.3 | 87,400 | 87,400 | 2.26 | 2.26 |
| 35 | C18 | 52 | 5 | 130.1- | 130.6 | 79,700- | 82,300 | 2.18- | 2.22 |
| | | | | 131.1 | | 83,500 | | 2.31 | |

While only certain features of the invention have been illustrated and described herein, many modifications and changes will occur to those skilled in the art. It is, therefore, to be understood that the appended claims are intended to cover all such modifications and changes as fall within the true spirit of the invention. All cited U.S. Patents are incorporated by reference herein.

1. A method for the production of a polyestercarbonate comprising the steps of:
i) providing at least one dihydroxyaromatic compound
ii) providing a carbonate precursor,
iii) providing at least one solid, biosynthetically derived, aliphatic alpha-omega dicarboxylic acid having about 10 to about 22 carbon atoms and having a nitrogen content of not more than about 55 ppm, and
reacting interfacially in the presence of a base said dihydroxyaromatic compound, said carbonate precursor and said dicarboxylic acid.

2. The method of claim 1 wherein the dihydroxyaromatic compound has the structure HO—D—OH, wherein D is a divalent aromatic radical with the structure of formula: 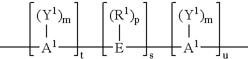
wherein A¹ is an aromatic group; E is at least one alkylene, alkylidene, or cycloaliphatic group; a sulfur-containing linkage; a phosphorus-containing linkage; an ether linkage; a carbonyl group; a tertiary nitrogen group; or a silicon-containing linkage; R¹ is hydrogen or a monovalent hydrocarbon group; Y¹ is selected from the group consisting of hydrogen, a monovalent hydrocarbon group, alkenyl, allyl, halogen, bromine, chlorine; nitro; and OR, wherein R is a monovalent hydrocarbon group; “m” represents any integer from and including zero through the number of positions on A¹ available for substitution; “p” represents an integer from and including zero through the number of positions on E available for substitution; “t” represents an integer equal to at least one; “s” is either zero or one; and “u” represents any integer including zero.

3. The method of claim 1 wherein the dihydroxyaromatic compound is at least one member selected from the group consisting of 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(4-hydroxyphenyl)propane; 2,2-bis(3-phenyl-4-hydroxyphenyl)propane; 2,2-bis(4-hydroxy-3-methylphenyl)propane; 2,2-bis(4-hydroxy-3-ethylphenyl )propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexyl methane; 2,2-bis(4-hydroxyphenyl)-1-phenylpropane; 2,4′-dihydroxyphenyl sulfone; 2,6-dihydroxy naphthalene; hydroquinone; resorcinol; a C₁₋₃ alkyl-substituted resorcinol; 2,2-bis-(4-hydroxyphenyl)-butane; 2,2-bis-(4-hydroxyphenyl)-2-methylbutane; 1,1-bis-(4-hydroxyphenyl)-cyclohexane; bis-(4-hydroxyphenyl); bis-(4-hydroxyphenyl)-sulphide; 2-(3-methyl-4-hydroxyphenyl-2-(4-hydroxyphenyl)-propane; 2-(3,5-dimethyl-4-hydroxyphenyl)-2-(4-hydroxyphenyl)-propane; 2-(3-methyl-4-hydroxyphenyl)-2-(3,5-dimethyl-4-hydroxyphenyl)-propane; bis-(3,5-dimethylphenyl-4-hydroxyphenyl)methane; 1,1-bis-(3,5-dimethylphenyl-4-hydroxyphenyl)ethane; 2,2-bis-(3,5-dimethylphenyl-4-hydroxyphenyl)propane; 2,4-bis-(3,5-dimethylphenyl-4-hydroxyphenyl)-2-methyl-butane; 3,3-bis-(3,5-dimethylphenyl-4-hydroxyphenyl)pentane; 1,1-bis-(3,5-dimethylphenyl-4-hydroxyphenyl)cyclopentane; 1,1-bis-(3,5-dimethylphenyl-4-hydroxyphenyl)cyclohexane; bis-(3,5-dimethylphenyl-4-hydroxyphenyl)-sulphide; 3-(4-hydroxyphenyl)-1,1,3-trimethylindan-5-ol, 1-(4-hydroxyphenyl)-1,3,3-trimethylindan-5-ol; and 2,2,2′,2′-tetrahydro-3,3,3′,3′-tetramethyl-1,1′-spirobi[1H-indene]-6,6′-diol.

4. The method of claim 1 wherein the dihydroxyaromatic compound is bisphenol A.

5. The method of claim 1 wherein the carbonate precursor is phosgene.

6. The method of claim 1 wherein the alpha-omega dicarboxylic acid is mono-unsaturated.

7. The method of claim 6 wherein the alpha-omega dicarboxylic acid is selected from the group consisting of cis-octadec-9-enedioic acid, trans-octadec-9-enedloic acid, cis-hexadec-8-enedioic acid, trans-hexadec-8-enedioic acid, cis-tetradec-7-enedioic acid, trans-tetradec-7-enedioic acid, cis-tetradec-5-enedioic acid, trans-tetradec-5-enedioic acid, cis-hexadec-7-enedioic acid, trans-hexadec-7-enedioic acid, cis-10-eicos-10-enedioic acid, and mixtures thereof.

8. The method of claim 1 wherein the alpha-omega dicarboxylic acid is saturated.

9. The method of claim 8 wherein the alpha-omega dicarboxylic acid is selected from the group consisting of sebacic acid, dodecanedioic acid, C₁₄-, C₁₆-, C₁₈-, C₂₀-, and C₂₂-dicarboxylic acids, and mixtures thereof.

10. The method of claim 9 wherein the alpha-omega dicarboxylic acid is a C₁₈-dicarboxylic acid.

11. The method of claim 1 wherein the dicarboxylic acid is a mixture of at least one mono-unsaturated dicarboxylic acid and at least one saturated dicarboxylic acid.

12. The method of claim 5 wherein phosgenation is performed at an initial pH of about 8 and the solid dicarboxylic acid has a mean particle size of not more than about 105 microns.

13. The method of claim 12 wherein the said dicarboxylic acid is ground and sieved to obtain the desired particle size.

14. The method of claim 12 wherein the dicarboxylic acid is substantially all incorporated into the polyestercarbonate.

15. The method of claim 12 wherein there is no emulsion layer is observed following completion of polyestercarbonate synthesis.

16. The method of claim 1, wherein the polyestercarbonate is isolated from the reaction mixture.

17. A method for the production of a polyestercarbonate comprising the steps of: combining bisphenol A; phosgene, and at least one solid, biosynthetically derived, aliphatic alpha-omega dicarboxylic acid having about 10 to about 22 carbon atoms and having a nitrogen content of not more than about 55 ppm, and reacting interfacially the components in the presence of sodium hydroxide.

18. The method of claim 17 wherein the alpha-omega dicarboxylic acid is a C₁₈-dicarboxylic acid.

19. The method of claim 17 wherein phosgenation is performed at an initial pH of about 8 and the solid dicarboxylic acid has a mean particle size of not more than about 105 microns.

20. A method for the production of a polyestercarbonate comprising the steps of: combining bisphenol A; phosgene, and at least one solid, biosynthetically derived, aliphatic alpha-omega C₁₈-dicarboxylic acid, and reacting interfacially the components in the presence of sodium hydroxide, wherein phosgenation is performed at an initial pH of about 8 and the solid dicarboxylic acid has a mean particle size of not more than about 105 microns and a nitrogen content of not more than about 55 ppm.
